(19) United States
(12) Patent Application Publication
(10) Pub. No.: US 2005/0278418 A1
(43) Pub. Date: Dec. 15, 2005

(54) System and method for use of multiple applications

(76) Inventors: Chandrasekar Rathakrishnan, Singapore (SG); Kong Lum Hon, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/511,773

(22) PCT Filed: Apr. 17, 2003
(86) PCT No.: PCT/SG03/00089

§ 371 Date: Oct. 19, 2004

(30) Foreign Application Priority Data
Apr. 19, 2002 (SG) 200202352-1

(51) Int. Cl. G06F 15/16

(52) U.S. Cl. 709/203

(57) ABSTRACT

A system for a server to stream data to a user's machine, wherein the data is sent to the user's machine as a stream of data for display on the user's machine with a resolution determined by the ability of the user's machine to display the data. The data may be for the user's machine to operate an application, wherein the application is executed on the server and such data as is required for the user's machine to operate and display the application is sent to the user's machine. The user's machine has a display device, the data being streamed to accord with a resolution requirement of the display device, the display device acting as the display device of the server. An operating system is used to enable the server to execute the application for display on the display device, the operating system being in a single operating layer architecture in the user's machine. The data may be an HTML media file to be displayed on a display device of the user's machine, the HTML media file being converted by the server from a media format to a universal media format agreed between the server and the user's machine and/or being resized before being streamed to the user's machine. The application is executed in a protected environment in which access controls are implemented to restrict access by the application to at least one restricted area of the system. The installation may be sent by the server to the user's machine with instructions for automatic installation on the user's machine, the instructions being packaged with the installation prior to being sent to the user's machine so that, upon receipt by the user's machine, the user's machine can unpack the installation and the instructions, execute the instructions, and launch the installation on the user's machine.

### FIELD OF THE INVENTION

The present invention relates to a system and method for the use of multiple applications and refers particularly, though not exclusively, to such a system and method for use in a mobile computing environment.

### DEFINITIONS

Throughout this specification a reference to a machine is to be taken to include a reference to a personal computer (“PC”), desktop computer, laptop computer, notebook computer, personal digital assistant (“PDA”), and mobile/cellular/hand telephone (“mobile ‘phone”).

### BACKGROUND OF THE INVENTION

Most computer applications are intended to be used on a personal computer or desktop computer. As such they quite often include very large files, and are RAM intensive. To deal with normal communications to a user's machine such as by email or for access to the World Wide Web or any form of media playback, will require the machine to have several applications installed and, possibly, open at the one time. With the hard disk and RAM available in most PCs, this is normally not a problem. For many notebooks, and especially for PDAs and mobile phones, it is a significant problem. Quite often, therefore, they use a scaled-down version of the applications, or can't use all relevant applications. This is causing difficulties, particularly when using a mobile phone or PDA to communicate with a PC, or the like. It also means that the use of PDAs and mobile phones is limited to those applications they are capable of running. The ability to interoperate applications written for other operating environments within a single operating system is not possible with any type of machines. Applications are written specific to one environment eliminating interoperability.

### CONSIDERATION OF THE PRIOR ART

The mobile computing environment has been lacking a solution to truly empower the industry. There has been no software that has been able to unlock the potential of mobile hardware which is largely limited especially when in comparison with Desktop hardware. Operating systems of desktop computing environment have been stripped down and embedded within a mobile device. In the process it inherits the flaws of the operating system. Some of the current offerings include Win CE, Palm OS, Symbian and Java OS. The only real difference between these stripped down operating systems is that they are from different vendors.

They are all modeled on similar architecture with differing interfaces. These embedded operating systems are all modeled on desktop computing with applications accessed from the desktop environment and executed on a different layer. This was the exact model and architecture that was propagated by Windows and Mach OS in the personal computing environment. The model was suited for the personal computing environment because of the availability of extensive processing power and sophisticated hardware such as, for example, hard disk drives, high memory modules, powerful video cards and excellent sound cards. Within the embedded space of a mobile device there are no such hardware capabilities. In this space, hardware limitations are high. Low processing capabilities, small storage capacity, limited memory modules, are what are generally found in the embedded space. The full-scale versions of the operating systems do not afford a user with optimal performance and experience despite using sophisticated hardware. Users experience crashes, performance latencies, and the need to deal with different formats that require different players from different vendors.

This results in the stripped-down versions unacceptable performance levels. Hence they fail to achieve their intended purpose of empowering users with the ability to compute “on the go”.

The use of multiple layered full-fledged operating systems embedded into mobile devices as stripped down versions is a compromise.

It is therefore the principal object of the present invention to provide a system and method for the use of multiple full-fledged applications on a user's machine, particularly a mobile machine such as, for example, a PDA or mobile phone where the applications execute on a server and not on the user's machine. The applications can also be manipulated on the user's machine.

A further object of the present invention is to provide such a system whereby a display device of the user's machine acts as the display device of the server, allowing for manipulation natively on the user device.

A final object of the present invention is to provide such a system whereby the server sends data for display on the user's machine's display device in accordance with the resolution of the display device in an automated fashion.

### SUMMARY OF THE INVENTION

With the above and other objects in mind the present invention provides a system for a server to stream data to a user's machine, wherein the data is sent to the user's machine as a stream of data for display on the user's machine with a resolution determined by the ability of the user's machine to display the data. Data includes bytes of codes.

In another form, the present invention provides a system for a server to enable a user's machine to operate an application, wherein the application is executed on the server and such data as is required for the user's machine to operate and display the application is sent to the user's machine as a stream of data for display on the user's machine with a resolution determined by the ability of the user's machine to operate and display the application.

The present invention also provides an application service provider operating system wherein an application is executed on a server, the server being for streaming data for display on a display device of a machine of a user, the data being streamed to accord with a resolution requirement of the display device, the display device acting as the display device of the server. A plurality and variety of applications may be executed on the server, all applications being executed on the server under a single operating system such that the data is streamed to the display device without the plurality of applications having to start or require the presence of their native operating systems.

In a further form, the present invention provides a software system for enabling a server to execute an application for display and manipulation on a display device of a user's machine, the software system being in a single operating layer architecture in the user's machine. The software system may include a platform for operating on the user's machine; the platform including a platform engine operating as an operating system. Preferably, the operating system is for security, driver support, power management, boot loader, and file system. The single operating layer architecture may also be used in the server.

The present invention also provides a system for a server to stream data to a user's machine to enable any media file to be displayed on a display device of the user's machine, and with any such media file being converted by the server from a media format to a universal media format agreed between the server and the user's machine. Through the conversion constant compression rates are ensured to allow real-time streaming of the data.

Further provided by the present invention is a system for a server to stream data to a user's machine to enable an HTML file to be displayed on a display device of the user's machine, the server including an HTML resizing server for resizing the file before sending the file to the user's machine. Any images in the HTML file may be resized to be able to be fully displayed on the display device. The HTML file is parsed and the code amended, on the server, to enable the HTML media file to be displayed on the display device. This process is performed in an automated fashion.

In yet a further form, the present invention provides a system for enabling a server to enable a user's machine operate an application executed on the server, wherein the application is executed in a protected environment in which access controls are implemented to restrict access by the application to at least one restricted area of the system. The application may be copied into the protected environment before execution.

In a final form, the present invention provides a system for a server providing an installation to a user's machine, the installation being sent by the server to the user's machine with instructions for automatic installation on the user's machine, the instructions being packaged with the installation prior to being sent to the user's machine so that, upon receipt by the user's machine, the user's machine can unpack the installation and the instructions, execute the instructions, and launch the installation on the user's machine. The installation may be a device driver, in which case the device driver files are copied to the system file locations and the system settings updated. A record may be kept of device driver installations used on the user's machine so that device drivers that are more frequently used are maintained in a memory of the server. The memory may be a read-only-memory.

The installation may be an update for an operating system operating on the user's machine, in which case a new file in the installation is copied to the server.

The present invention also extends to all possible combinations of all forms of the invention.

### DESCRIPTION OF THE DRAWINGS

In order that the present invention may be fully understood and readily put into practical effect there shall now be described by way of non-limitative example only a preferred embodiment of the present invention, the description being with reference to the accompanying illustrative drawings in which:

FIG. 1 is an overall flow chart for the platform to be used on a user's machine;

FIG. 2 is a flow chart for the user authentication of FIG. 1;

FIG. 3 is a flow chart for viewing an HTML file of FIG. 1;

FIG. 4 is a flow chart for launching a multimedia plug in of FIG. 1;

FIG. 5 is a flow chart for the launching of a remote application of FIG. 1;

FIG. 6 is a flow chart for a system update of FIG. 11

FIG. 7 is an overall flow chart for the platform's response to an input;

FIG. 8 is a flow chart for a user's input of FIG. 7;

FIG. 9 is a flow chart for a system input of FIG. 7;

FIG. 10 is a flow chart for a server input of FIG. 7;

FIG. 11 is an overall flow chart for the server operation (first part);

FIG. 12 is an overall flow chart for the server operation (final part);

FIG. 13 is a flow chart for user authentication of FIGS. 11 and 12;

FIG. 14 is a flow chart for resizing and caching an HTML file of FIGS. 11 and 12;

FIG. 15 is a flow chart for the streaming of media of FIGS. 11 and 12;

FIG. 16 is a flow chart for the launching of an application (first part);

FIG. 17 is a flow chart for the launching of an application (final part);

FIG. 18 is a flow chart for a device driver request of FIGS. 11 and 12;

FIG. 19 is a flow chart for an update of the operating system of FIGS. 11 and 12;

FIG. 20 is a system architecture diagram for the platform;

FIG. 21 is a system architecture diagram for the server engine, and

FIG. 22 is a diagram for application hosting.

### DESCRIPTION OF THE PREFERRED EMBODIMENT

Although the description that follows is relevant for a mobile computing environment (mobile phone; PDA; etc) the present invention can be used with any machine able to communicate with a server over a telecommunications network.

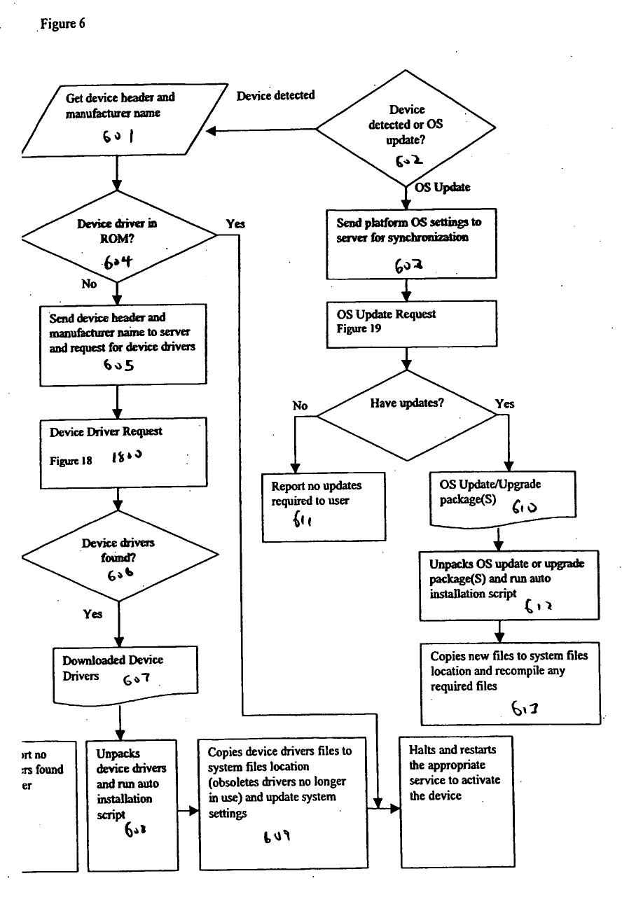

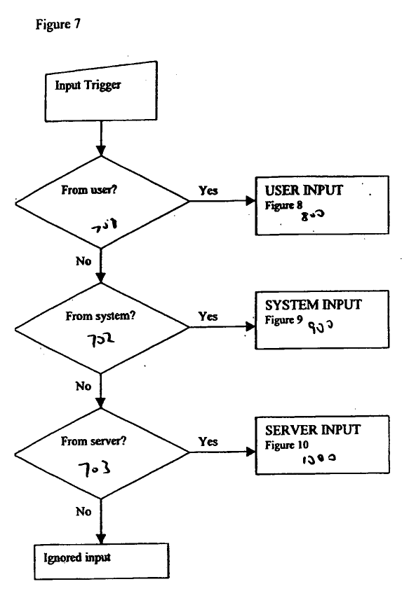

In the following description, reference numerals will be used with the first two numerals denoting the figure in which the object can be found. For example, 0605 refers to object 5 in FIG. 6 and 0700 refers to FIG. 7.

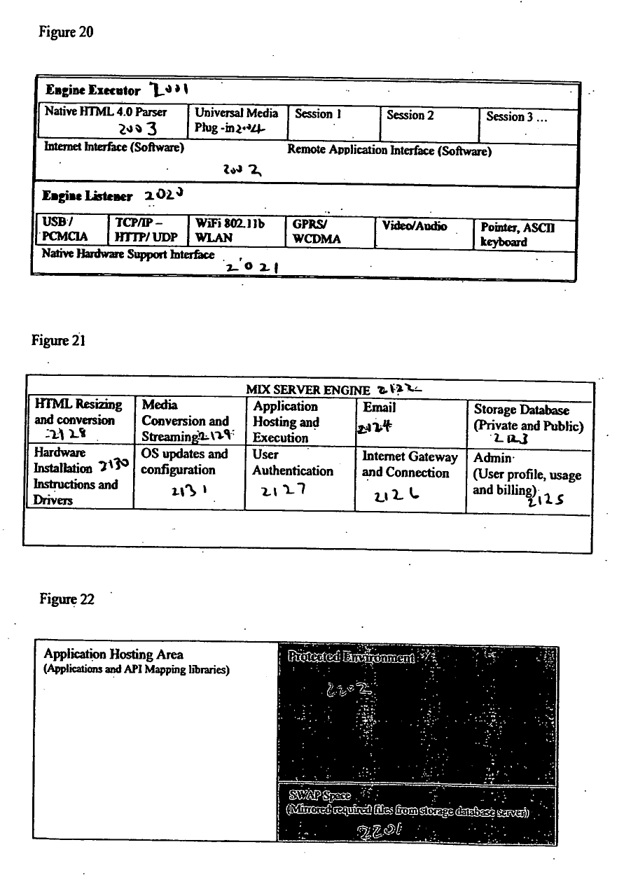

To first refer to FIG. 20, the platform is built on the Single Operating Layer Architecture (“SOLA”), and has an engine executor 2001 and an engine listener 2020. The engine executor 2001 provides the software interface 2002, including the Internet interface and remote application interface. The engine listener provides the native hardware support interface.

The platform has only its engine. The shell that the platform engine provides is natively rendered by the platform engine. The platform engine provides HTML and multimedia output as native I/O support. There are no APIs provided, eliminating the application layer. This also reduces the chances of third party applications being able to gain direct hardware access. In this way, any native access has to be screened by the platform engine. Applications do not run on top of the platform engine. Instead, sessions are created to handle applications and they run remotely on a server.

No application calls any APIs, thus there is no software layer. Instead, APIs that are called from remote applications are translated to commands that are shared between the server engine and the platform engine. This is why no applications run on top of the platform engine. At any time, the platform engine only accepts instructions from the user, and the server. Additionally, web content is allowed to call commands that can be used for hardware processing tasks. Such calls are different from APIs calls because commands are parsed each time they are called, so there is no direct hardware resource access by web content and remote applications.

As the applications run on the server they do not need to be a stripped down version of an existing OS. The platform engine receives the required data from the server engine. It is then displayed on a display device (screen, etc) of the user's machine. The capability to support HTML 4.0 web content means that full web experience is brought to the user with the platform, on a mobile machine. When first connecting to the server the platform provides details to the server of the user's machine (including the resolution of its display device) so that all data sent to the user's machine will be able to be processed by the platform, and displayed on the display device of the user's machine.

The universal multimedia format 2004 allows users to request any rich media content of any file format and having the capability to playback converted versions of the content; eliminating the need of several plug-ins, that utilizes extensive memory (RAM) of the machine. The universal multimedia format 2004 gives consistency of compression so that the compression of the media file will be consistent notwithstanding different developers. This allows for efficient use of bandwidth at all times.

Launching, manipulating and multi-remote tasking of applications means faster application handling since execution is not at the local end. Instead monitoring and manipulating is done locally. Switching from one application to another is relatively quick since the OS on the local end does not require memory paging or program switching.

External peripheral devices support and auto-installation means that users need not know the required drivers and installation instructions. Instead, the platform requests the required drivers, and automatically installs the required drivers. As such, integrity of system drivers may be high since the server knows what the platform can support, and will feed necessary details for automatic installation. The platform can perform automatic installation of drivers for the use of peripheral devices

The platform engine's engine executor defines the software capabilities while the engine listener defines the hardware capabilities.

The native HTML parser means 2003 that the platform engine natively has the capability to parse HTML. Unlike other OSs that rely on browser applications to parse and render HTML output, the platform engine parses and renders it natively. This provides a standardized output of HTML content, and allows format consistency across all mobile devices.

The standard used for the Native HTML 4.0 Parser 2003 is based on the NCSA Mosaic(TM) and W3C standards. However, the native HTML browser module can read all rich media content without an external player or plug-in. Given the URL, the browser will request resizing of the original the HTML content by sending the resolution screen size and color depth specifications of the user's machine's display device to the server. Based on the resized HTML file, the browser checks for any content—rich media attached. If any, the browser will launch the universal multimedia plug-in 2004, a plug-in that will retrieve multimedia content in a universal format, from the server.

The term plug-in is used due to the nature of the function, since it is within the HTML parser and is used when required. However, it is not a standard plug-in that is installed in browsers or applications. On demand it requests resizing and converting of the source media file format to the universal media format by sending the resolution at the user's machine to the server. The universal media format is a standard media format and preferably has high compression rates to allow real time streaming. Since the format has no effect on the processes, it can be any format that is pre-determined by both the platform and server.

By doing this the need for several plug-ins is eliminated since only one format is retrieved. This gives consistency in media format, resolution control, and compression rates.

The platform engine does not allow an application to run on top of it. Therefore, the platform engine provides basic I/O interfaces, including keyboard, speakers output, and USB support. However, the platform engine allows sessions of applications to be created, so that the platform engine can manipulate applications that are executed on the server. This is a network computing technique that is incorporated into the SOLA so that memory use optimization, and fast multitasking, can be achieved. Generally, the remote application interface allows launching, executing, manipulating, monitoring and quitting of applications at the server, from the user's machine.

Given the URL address of an application, the remote application interface will send the user's machine screen resolution with the request to remotely launch the application. In return, the remote application interface will receive GUI instructions to display GUI components on the screen of the user's machine once the application is successfully launched and executed. Upon receiving the GUI instructions, the remote application interface will create the GUI components and allow interactivity of the components to be done locally without server intervention. Only when a process, such as sorting or saving files, is required will the remote application interface send a call that indicates which part of the program has to be executed at the server. The server sends back GUI instructions to the remote application interface to update its view port. The remote application interface also checks if the application, while being processed at the server, calls any commands or hardware request. Both the server engine and platform engine re-direct to the other engine commands that belong to the other engine.

The platform engine has built-in hardware interfaces and extensions are not required as it is an embedded environment. Moreover, allowing a choice of hardware extension supports compromise OS security. The platform engine recognizes pre-programmed hardware and will not work with unauthorized third party hardware. By doing this, hackers are prevented from exploiting third party hardware to gain access to the user's machine.

The native hardware support interface is the engine listener for the platform engine. Its main tasks are to listen for hardware operations, and detections. The engine listener is programmed to “listen” to fixed categories of hardware. Since different hardware uses different drivers, the engine listener is a “driver layer” that allows standardized hardware access.

There are only two ways in which hardware access is granted. The first is by calling commands. As commands are parsed and interpreted each time they are called, no applications or web content can directly access hardware resources. The second is by calling conventional OS APIs. As a subset of the APIs is converted to commands, hardware access is also allowed in this way. However, since only a subset of the APIs can be converted, hardware access by conventional API calling is not always allowed. API calls that reference address and allocations of memory segrnents, direct port referencing, native transferring of binary codes, hooks and interrupts programming, are all insecure API calls that will not be converted to commands. The platform engine supports conversions of higher level of API calling, such as opening of CD-ROM Drive Bay, adjusting of volume, printing documents, and so forth. Conversion of conventional APIs to commands is done at the server.

Any wireless support hardware will be detected and auto-installed as the platform engine provides native integrated hardware support. This is with the help of the server. The server helps the platform engine to identify installation instructions for the detected devices. As such, user intervention is not longer required

As shown in FIG. 21, the server operates in a similar single layer as the platform. However, since the server operating system is much more complex and is not in an embedded environment, there are extensions to the server. All the components listed under the server engine 2122 are individual servers, except that they are programmed to “listen” to commands that are called from the server engine. The server engine also coordinates and re-directs operations to the respective servers.

The server also reacts and listens to the platform. Therefore, the server engine is in the “front line”. The server engine does not provide native support for all its services, but it acts an interface to all its services. Each of the services is hosted by their respective servers. They may be part of the server suite of servers, or can be from an external party. For example, the storage database server of the server suite can be replaced by an ”Oracle” database server. However, the storage database server from the server suite must remain, as extensions are installed on it to enable the server to connect to a third party database server. All the servers in the suite are integrated to the server engine as they interact with each other. The only exception is when third party servers are required. In this case, as is mentioned above, extensions are insalled on the respective server to connect to the external servers. This applies to email 2124, storage database 2123, administration 2125, Internet gateway 2126, and user authentication servers 2127.

Storage on the server side eliminates the need to synchronize data since data is available at real time. By having the processing on the server, mobile machines can launch applications that were built for PCs with large RAM, large hard disks, and high processor and bus speeds. Furthermore, the splitting of operations reduces traffic between the server and the user's machine.

Multi-sessions mean the server can support more users than conventional application hosting servers, as the server handles session data rather than application data, which is resource intensive. Also, as the application is executed on the server, virus attacks cannot be made directly at the user's machine as there is no application running on the user's machine, and a virus normally attaches itself to a designated part of an application. As the user has to go through the Internet gateway at the server, security can be handled in a more efficient manner as the server can track and monitor through-load balancing techniques, and firewall security.

The server identifies each of the users by the MSISDN information that is unique and secure. Leveraging on such a tracking system can potentially provide payment identification billing systems. It also allows the server to grant users access from any network, as long as the user has the same MSISDN.

The HTML resizing and conversion server 2128 is one of the servers in the server suite of servers. It is a data processing server as it retrieves web content from the Internet, and resizes the content. This server works on a basis of pre-programmed scripts that are instructions on the resizing of HTML documents.

Once the URL of the HTML document, and the resolution of the user's machine, are fed to the server it checks to determine if the required document is already in its cache. Documents that are not in the cache will be obtained from the Internet. Upon retrieving the document from the Internet, the server will, apart from saving its operations to a log, add WIDTH and HEIGHT tags to objects in the HTML document that do not have these tags. It then amends values in the WIDTH and HEIGHT tags so that they can be viewed on the user's machine display device in the requested resolution. This is done by dividing the original WIDTH by 800 and multiplying it by the requested resolution's width. In most cases, HEIGHT tags are not amended, unless by user request. If so, the value of HEIGHT will be divided by 600 and multiplied by the requested resolution's height. The text in the HTML document is resized by either amending the SIZE value in the FONT tag, dividing it by 4, or by adding cascading-style sheets that override all the FONT tags and use font size 1. Since the IMG tags WIDTH and HEIGHT values are changed, sending the original graphic file to the user does not excessively utilize bandwidth as if a larger file was sent. Therefore, if a smaller size of the original graphic file is attached to the HTML document, it will be resized so that the file is smaller. Resizing of a graphic file depends on its format. It can be JPEG compression or GIF compression. The graphic files are resized to the displayable resolution. Unnecessarily large files are not sent. Further amendments to the HTML code are made when the server resizes tables, embed, form, input and other tags supported by the platform 0100. This is not transcoding as no images are discarded and the layout of the HTML document will be exactly the same as the original design. Any resizing work will be cached for later reuse.

The advantage of having HTML resizing and conversion on the server is that pre-processors can be put in place to ensure the user will receive HTML content that fits the screen of their machine. Another advantage is that it allows images to be compressed before they are sent to the user, the image having been resized to a smaller resolution to match that of the user's machine's display device.

The media conversion and streaming server 2129 is both a conversion and streaming server, though the actual processing may be on separate machines to give better performance. Conversion is data processing intensive by nature, while streaming is bandwidth and sessions monitoring intensive.

There are two ways to converting the media format to the universal media format. The universal media format is a industrial standard format that the server and platform 0100 have agreed upon as the only format they will share with each other in order to eliminate the need for plug-ins to play multiple formats. The criteria for the choosing the universal media format is that the format must be a streaming format, and should have constant compression rates to fulfill real time streaming.

The first approach is to use existing transcoding techniques to convert from one media format to the other. Transcoding techniques are not available for all format conversions, since some formats do not use asymmetrical compression and encoding. Therefore, the second approach has to be used if the first approach is not feasible. The second approach takes more time and processing power. It involves decoding and decompression of the original media format to raw data, such as bitmap frames and PCM waves. Again, since each media format has its own decoding and encoding algorithms, the purpose of the conversion is not to better compress or encode the media files. Rather, it is to give constant compression rates and to eliminate multiple plug-ins on the platform 0100 for it to be able to view multiple formats.

Resizing is also performed so that the server streams smaller files to the platform 0100. Any conversion and resizing performed is automatically cached for later reuse. After conversion and resizing, the server streams it to the platform 0100.

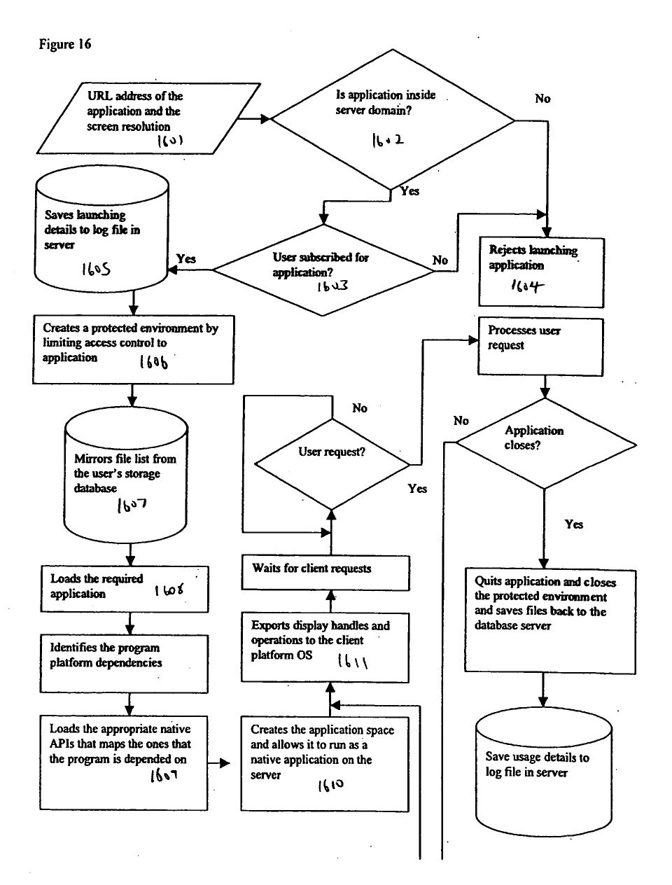

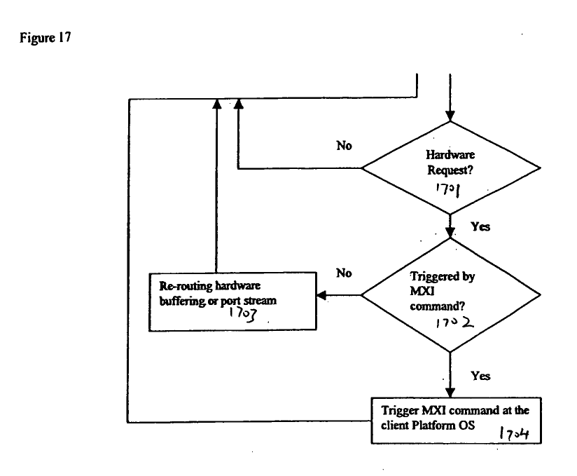

The application hosting and execution server is the hosting and execution environment of the server. Since the platform 0100 does not provide a local hosting and execution environment, it leverages the server's application hosting and execution server to launch and execution applications. See further description below of FIGS. 16 and 17.

The email server is a standard email server that works with the server engine. It also allows scripting and programming extensions to connect to other email servers. This allows the server to be compatible with other email servers.

The normal operations of the email server do not differ from standard servers. However, when an email is to be sent or received, the email server will check the user profile to determine if the user has subscribed to a third party email server. If so, the email server will first use the extension scripts written for the third party email server, login using the user's user ID and password, and send or retrieve email. If an email is retrieved, it stores the email in the user's email account. It then logs out from the user's third party email server account.

The email server provides not only email access, but also compatibility extensions so that users can log in to different servers.

The storage database is a hosting server that utilizes a database to allocate quota, and implement access controls to the user space. Its primary role is to provide disk access to platform 0100 users.

The databases that allocate quota, and implements access controls, preferably has at least five fields: user ID, quota limit, password, private access directories, and public access directories. The private and public access directories each has different access rights that provide access in different ways. The private access directory is a “view only” directory whereby users can open copyrighted files but cannot forward them to third parties, or to other directories. The private access directory is into one which content providers can write copyrighted media files, when the user has subscribed to or bought the content from them. The public access directory is a normal disk space where users can create, copy, erase and open files. It has no access restrictions, and users can open applications that use files stored in the directory.

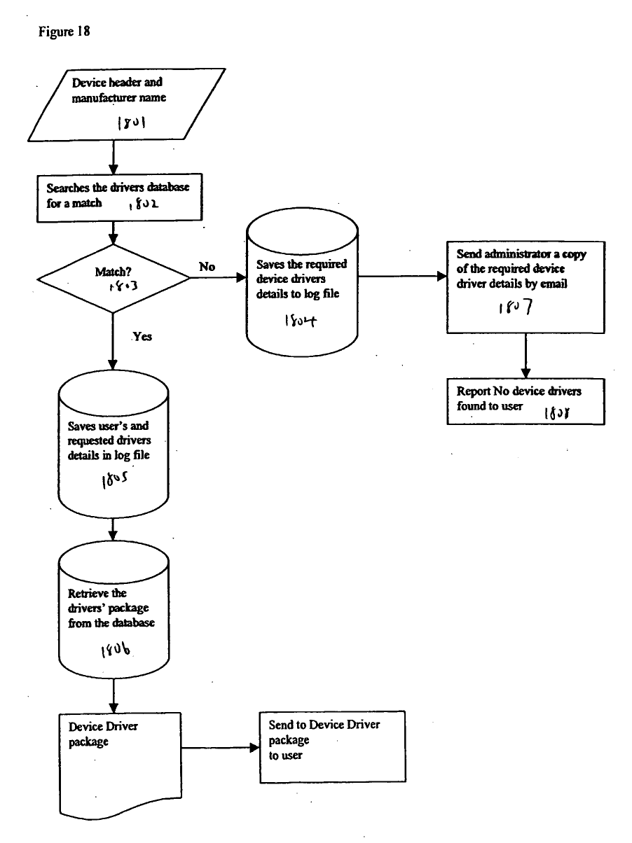

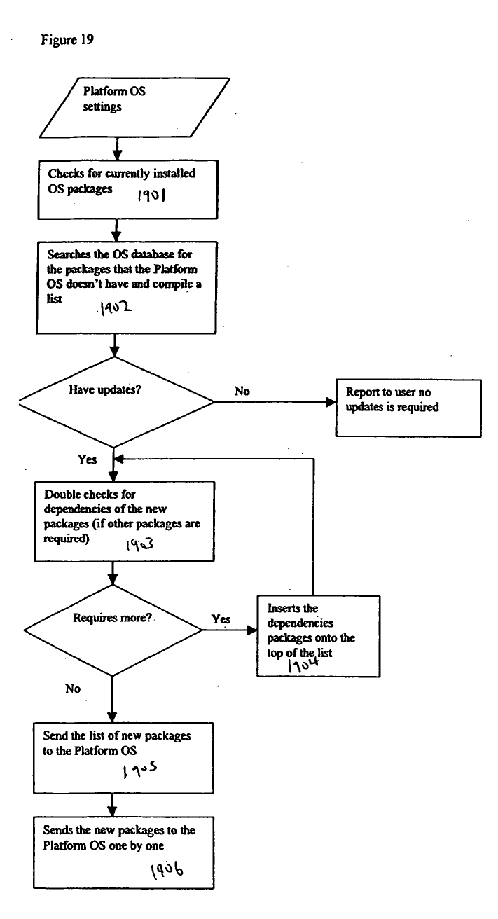

The hardware installation 2130 and OS update 2131 server is a database server that stores all the hardware drivers and OS updates. Upon demand from the platform 0100, the server will search for the appropriate hardware drivers or OS update package, and send it to the user. Such packages sent are unique to the platform 0100 as it carries scripts that instruct the platform 0100 how to install the drivers of OS updates so that users need not intervene in the process. See also the description below of FIGS. 18 and 19.

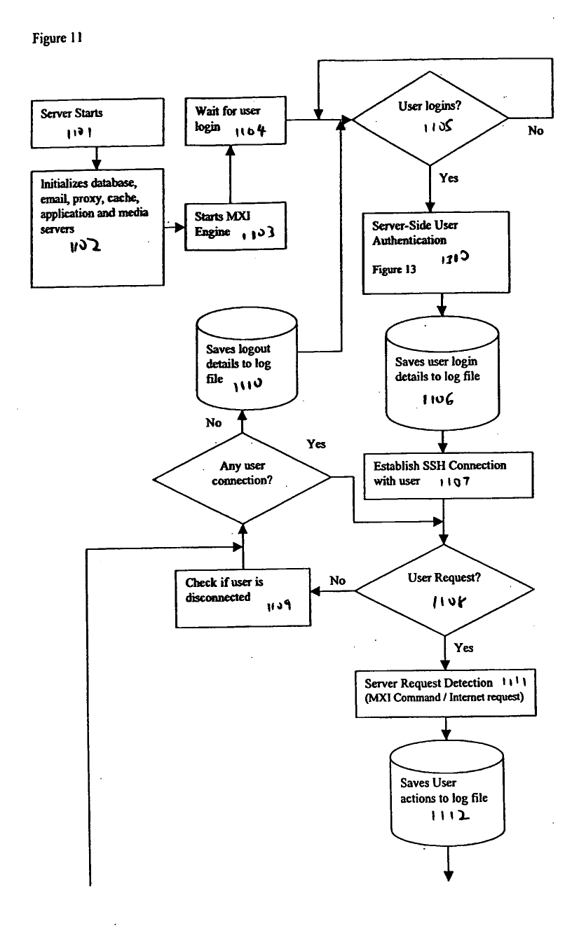

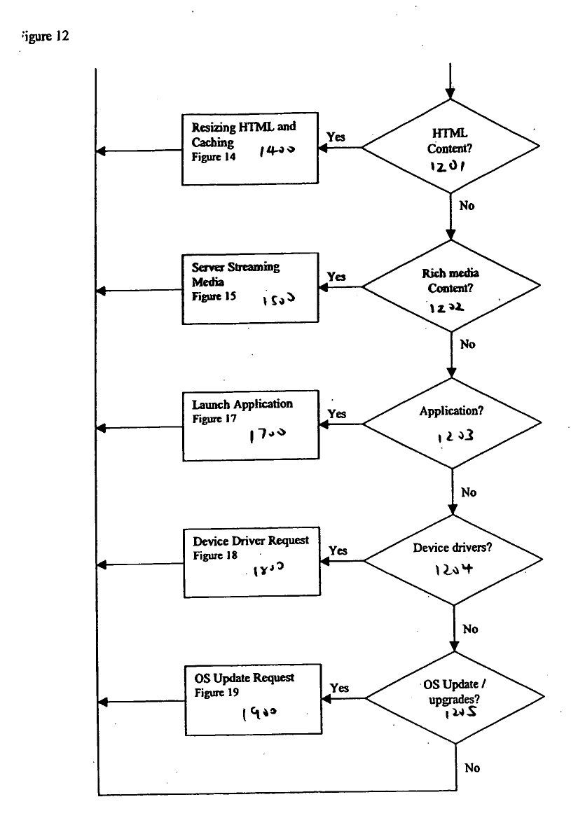

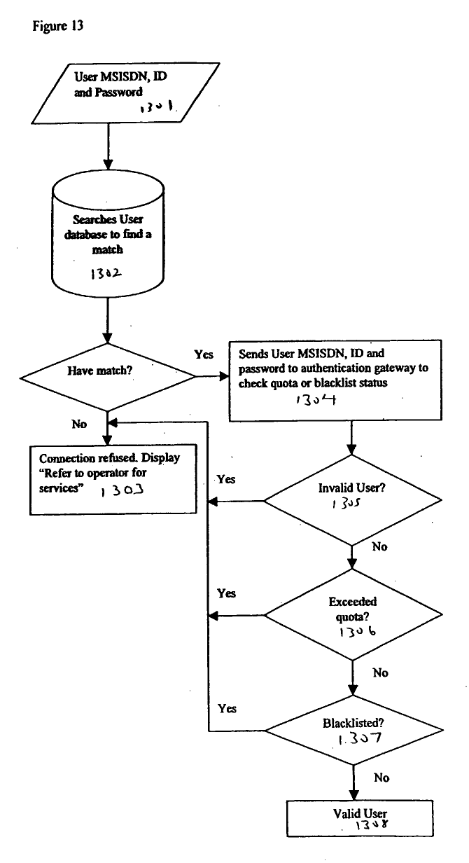

The user authentication server is described in relation to FIG. 13.

The Internet gateway is a standard gateway server or a proxy server. It may have a different implementation of queue systems, and security firewalls. The admin server is the central repository of usage logs, configuration panel, and monitoring mechanisms. The administrator of the network is able to: alert new OS updates; check if any hardware drivers not found in the database are required by the users, monitor storage database; configure the application server; create user accounts; generate billing and usage reports; set security policies; server updates; and modify configuration settings of all servers.

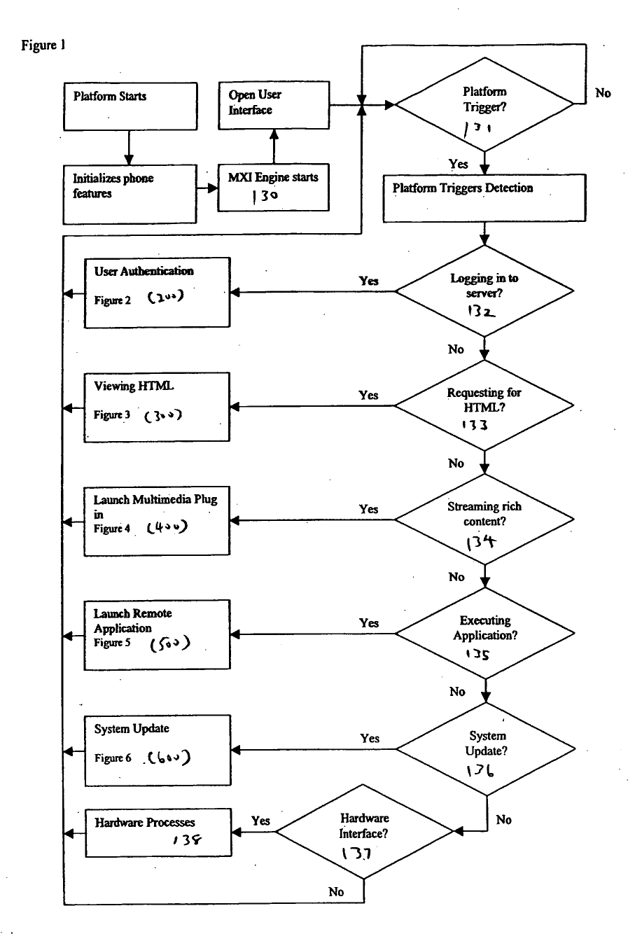

To refer to FIG. 1, there is shown a platform 0100. This is the operating system residing in the user's machine. It connects and interacts with a server for login, request for web content-rich media, applications, and system updates. “Phone features” refers to generic telephone functions like cell phone calls, SMS, address books, contacts, calendar, and so forth.

The engine is the command interpreter and invoking engine 0130 that does all the required local processing and network control. The engine 0130 handles all the operations and only reacts if there's a trigger. It then branches to the different services offered by the engine system. Services offered by the engine include handling Internet connectivity, playback of web content-rich media, launching applications remotely, system settings, and peripheral support. The engine merges layers of a traditional operating system, providing integrity in operations, speed of execution, and efficient memory control.

A platform trigger 0131 is a trigger that is invoked at the user end. This includes: user input through touch screen, keyboard, command, or system input.

The platform 0100 boots up and starts. After the phone features are initialized, the platform 0100 engine will be started. The platform 0100 engine then renders and opens the user interface. The platform 0100 engine will start listening for platform triggers. When there is a platform trigger, the platform trigger detection process will be executed to detect what type of trigger is invoked. If it is a “logging in to server” trigger 0132, the user authentication process 0200 will be launched. If it is a “request for HTML” 0133, the viewing HTML process 0300 will be launched. If it is requesting for streaming content-rich media 0134, then the “launch multimedia plug-in” process 0400 will be launched. If the trigger is a call for an application to be executed 0135, the “launch remote application” process 0500 will be launched. If it is a system update 0136, the system update process 0600 will be launched. If the trigger is invoked by local hardware inputs 0137, the hardware trigger will be processed 0138. The platform 0100 will continue to loop and detect for platform triggers until it is shut down.

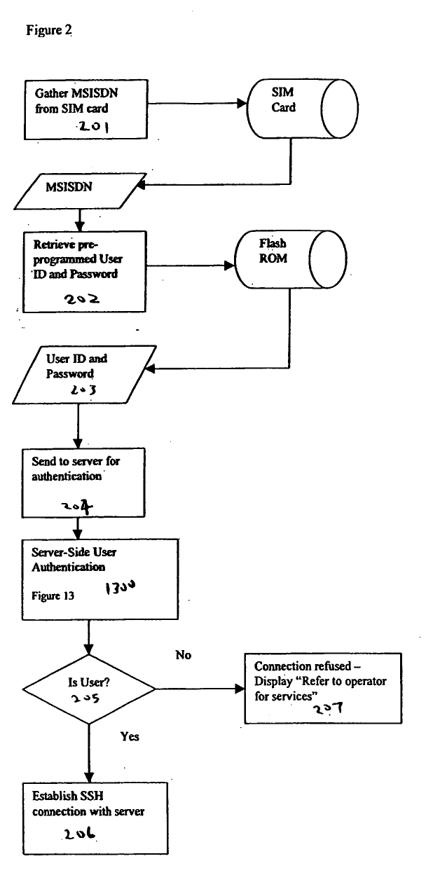

As shown in FIG. 2, once the platform 0100 starts and the user logs in, user authentication 0200 is invoked. This process involves retrieving the MSISDN from the SIM card module, the user ID and password for PKI, and submitting them to the server 0201. The user ID and password will be retrieved from the flash ROM of the user's machine. Both of these will be sent to the server for authentication 0204. The server user authentication process 1300 will be launched. Once the authentication process 1300 establishes that the user is valid 0205, it opens a SSH connection 0206 between the user and the server. Enhanced security measures are put in place as the initial authentication uses a SIM card. The authentication and secure tunnel is more secure than a conventional SSL connection. Moreover, by using a second layer login that uses the user ID and password, encryption and compression are provided on top of those provided by the telecommunication service provider. If it is not a valid user 0207, the user will not be admitted and the platform 0100 will display “refer to operator for services” on the user's machine's display device.

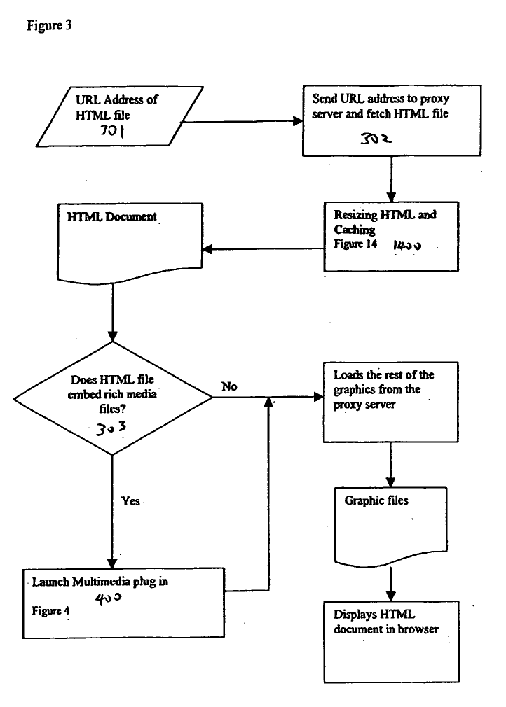

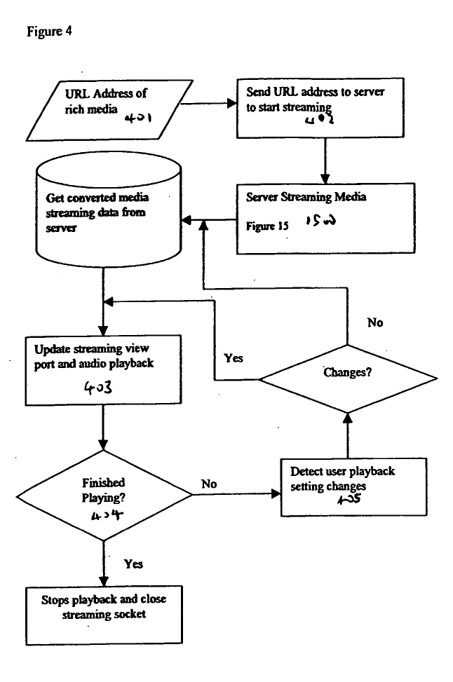

The viewing of an HTML file is shown in FIG. 3. Although the process of opening an HTML file is similar to a conventional HTML browser, the HTML browser module can read all content-rich media without an external player or external plug-in. Given the URL 0301, the browser requests the HTML content from the server 0302. Upon receiving the HTML content, the server resizes and caches it 1400. The browser then checks if any content-rich media is to be attached based on the resized HTML file 0303. If there is any, the browser launches its multimedia plug-in 0400. This is an internal plug-in that retrieves multimedia content from the server in a universal format. This is shown in FIG. 4.

The multimedia plug-in 0400 is a general purpose plug-in that retrieves a universal format for video and audio content. This eliminates the need for multiple plug-ins for multiple media formats. The server converts all conventional media formats to the universal media format. It is essentially a streaming media plug-in. It uses known, conventional streaming techniques and industrial compression techniques. The advantage is that it eliminates the need to have several plug-ins since it retrieves in one format only.

After the URL address 0401 of the media content is passed to the server streaming media process 0402, it will start the conversion of the media streaming data from the server 1500. The view port of the video and audio playback will be updated 0403. Until the file has finished streaming 0404, it will continue to obtain streaming data from the server. At the same time, it will check if the user triggers any playback settings that change the playback streaming sequence 0405. If there are changes, it will update the view port of the video and audio playback accordingly.

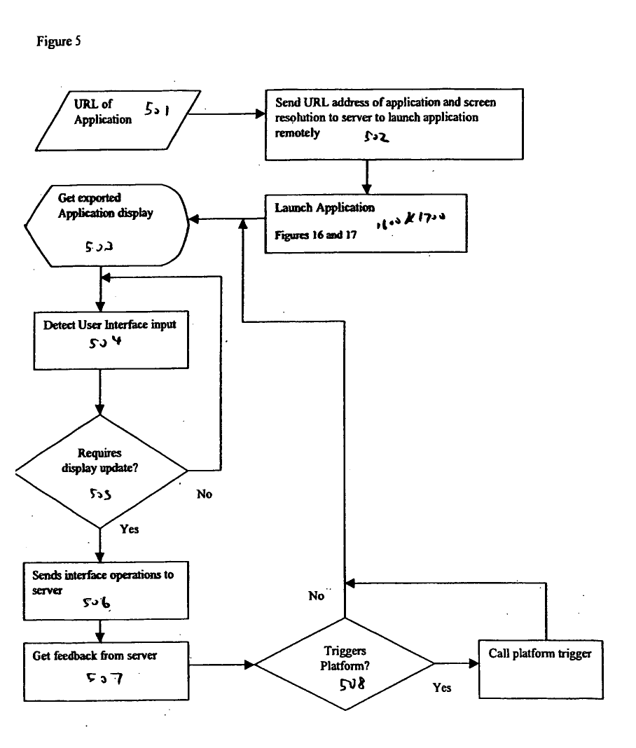

FIG. 5 shows the launching of a remote application such as, for example, desktop applications such as the “Windows” office productivity software or standard desktop applications. These are conventional desktop applications written natively for the desktop PC environment for OSs such as “Windows”, “Linux”, Java, and the “Palm” OS.

Given the URL address 0501 of the application, the platform 0100 sends its screen resolution to the server together with the request to remotely launch the application 0502. In return, once the application is successfully launched and executed 1600/1700, the platform 0100 will receive GUI instructions to display GUI components on the screen 0503. This is different from screen dumping or remote desktop technologies where the user does not know what is being received. Upon receiving the GUI instructions, the platform 0100 will create the GUI components and allow interactivity of these components to be performed locally without server intervention 0504. When a process such as sorting or saving files is required the platform 0100 refers back to the server. At all other times it operates locally. The platform 0100 also checks if any platform trigger is to be performed. If there is, it will allow the trigger to be invoked and the process proceed.

If the input process requires a display update 0505, interface operations will be sent 0506 to the server. The server will return feedback 0570. If the feedback is a platform trigger 0508, the platform trigger will be invoked. The exported application display will be retrieved, and user interface input detection will restart.

In the system update of FIG. 6, “device header and manufacturer name” refers to descriptions and manufacturer information of peripheral devices that are sent from the user's machine to the server during the initialization process 0601. Such information would normally be, for example, Device A Model name, Printer USB, Manufacturer B, Version 1.2.

OS update 0602 refers to upgrade packs or patches that are released to the user. Such updates are normally automatically accepted by the platform 0100, and an auto-update process is performed. When such an operation is to be performed, a OS update trigger occurs 0603.

Upon detecting a trigger the system update module will check to determine if it is an OS update, or external device. This is done by checking the source of the trigger. An OS update will only come from the server, and device detection occurs only at the platform 0100 side. Since peripheral devices that are installed can be used more than once, the driver files are stored in the ROM of the user's machine. Therefore, the next time the device is detected, it can be immediately activated by retrieving the required drivers from the ROM of the user's machine. During an initial installation, the platform 0100 will send to the server all details required by the server, which includes device header and manufacturer name. If a device is detected, a check on whether the device driver is in the ROM 0604 will proceed. If yes, then the appropriate service will be halted and restarted to activate the device 0605. If device driver is not in the ROM, the device driver request process 1800 will be launched. If device driver is not found a report is returned advising “no drivers found”. If the driver is found 0606, it is downloaded 0607, unpacked 0608, and the auto installation scripts within the package will be executed 0609. Device driver files will be copied to the system file locations, and system settings will be updated. Since there is a cap to the number of device drivers the ROM can support, the oldest device driver, or the least used device driver, will be declared obsolete and deleted from the ROM. After the updating is done, the appropriate service will be halted and restarted to activate the device.

An OS update is performed in a similar manner. Given an OS update trigger is invoked, the platform 0100 checks with the server to verify if there is an update required. If it is for an OS update, then the platform OS settings will be sent to the server for synchronization. After synchronizing, the OS update request will be launched. If there is no update, the user will receive a “no update” 0611. If there are updates, the OS update or upgrade packages will be received 0610. The packages are unpacked, and the auto installation scripts within the packages will be executed 0612. The scripts will instruct the platform 0100 to copy any new files to the system and recompile any required files 0613.

In FIG. 7, input trigger refers to inputs that are generated by the user 0701, platform 0702 and server 0703.

User refers to the person who is using the machine. Typical inputs 0800 are from instructions using a keyboard, mouse, pointer, or submitting a URL. System refers to the user's machine. The only possible input 0900 from the device itself is when the machine detects an external peripheral device and reports it to the platform 0100.

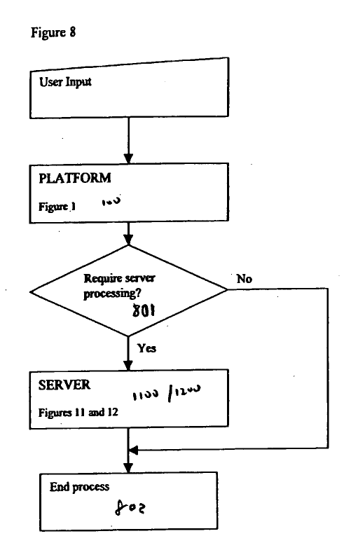

Server refers to the server hosted at a remote area that is networked to a telecommunications service provider or communication infrastructure that has a connection to the user's machine. There are two possible triggers/inputs from the server 1000. The first is an OS update alert, whereby the server alerts the platform 0100 of a new OS update, instructs it to download the patch/update, and installs it. The second possible trigger from the server is a command from the server. This will happen when an application that the user is currently using calls command, and it is processed at the server. However, if the particular command cannot be processed at the server (for example, a print function), the server will redirect the command function by instructing the platform 0100 to perform the function.

Where the input is from the user (FIG. 8), it may be categorized as either a request for services, or a login. Both inputs have to be processed by the platform 0100. A decision is made whether server processing is required after the platform has finished its processing. If the server is not required for further processing 0801, the processing stops 0802. Otherwise the server takes over the processing 1100/1200 until the request is processed.

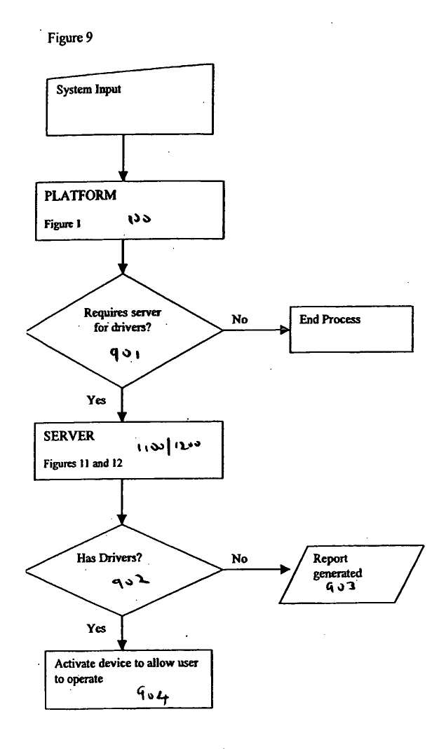

For a system input (FIG. 9), the only possible input is the detection of a new hardware device. The platform 0100 first performs all necessary pre-processing work, and determines it with any drivers have to be fetched from the server 0901. If drivers are required, the server will check if it has the required drivers 0902. If no appropriate driver is found, the server will generate a report stating what drivers are required by the users 0903. If the driver is found, it will be activated by the platform once the driver is installed on the system 0904. The user will be able to operate the new-installed hardware device upon the drivers being installed.

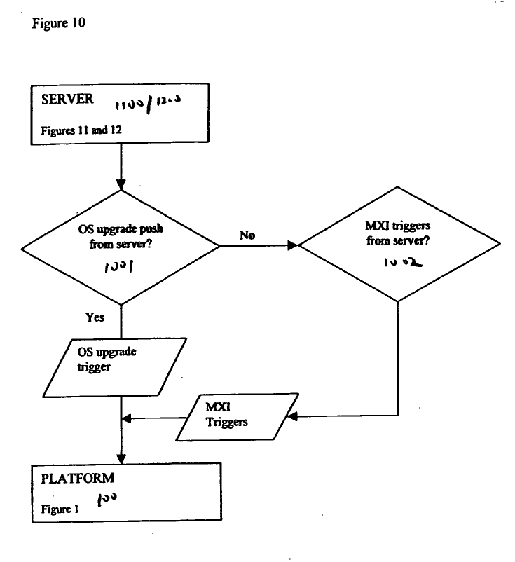

In FIG. 10 there is shown the response to a server input 1100/1200. A server input 1100/1200 is first formulated after the server has performed at least a small amount of processing. It will alert the platform of OS upgrades/updates 1001, or call commands from the server-side 1002 to instruct the platform 0100 for local processing, such as a print or scan function. Both such inputs are fed to the platform 0100 for processing by the platform 0100.

The operations of the server are shown in FIGS. 11 and 12. The server includes the software that resides in the server. The server is networked to the infrastructure of a telecommunications service provider. The basic components include a database, email, proxy, cache, applications, and a media server. The server engine provides communication and operation instructions at the server. The components in the server talk to each other using commands, and operations are only performed when such commands are issued. Each of the components in the server has an execution engine, while the main server possesses the server engine, which is the command interpreter.

When the server starts 1101, it initializes the database, email, proxy, cache, application, OS update and media server 1102 to ensure they are calibrated and work together. The server engine is then loaded 1103, and starts listening for user login 1104. When a user logs in 1105, the server authentication process 1300 will be launched. It saves the login details to the log file 1106 and establishes a secure shell (SSH) connection 1107 with the user. It proceeds to check if there are any user requests 1108. If no, it will check if the user is disconnected 1109. If the user is disconnected, details of the logout will be saved 1110. If user is still connected, the check will continue. When a user request is received, the server request detection will be invoked 1111. User actions are saved to the log 1112. If the user request is for HTML content 1201, the resizing and HTML caching process 1400 will be launched. If the request is rich media content 1202, the server streaming media process 1500 will be launched. If the user request is for an application 1203, the launch application process 1700 will be launched. If the user request is device drivers 1204, the device driver request process 1800 will be launched. If the user request is an OS update or upgrade 1205, the OS update request process 1900 will be launched. Otherwise the request is ignored and/or returned to the platform, and the server will continue to check for user request.

In FIG. 13 there is shown the server operations during user authentication. Here, authentication gateway refers to a separate server that handles user authentication in the telecommunications service provider. When the MSISDN, user ID, and user password are received by the server 1301, a search is made of the user database to find a match 1302. If there is no match the connection is refused 1303. Although the user logs in through the network of the telecommunications service provider, which means they have already passed one authentication process, the server will double check 1304 with the telecommunications service authentication gateway to determine if the request comes from a user that is blacklisted, has exceeded their provider quota, or is an invalid user who has not subscribed to the service. If the telecommunication authentication gateway returns the user as invalid 1305, exceed quota 1306 or blacklisted 1307, the connection is refused. Otherwise, the user will be verified as a valid user 1308.

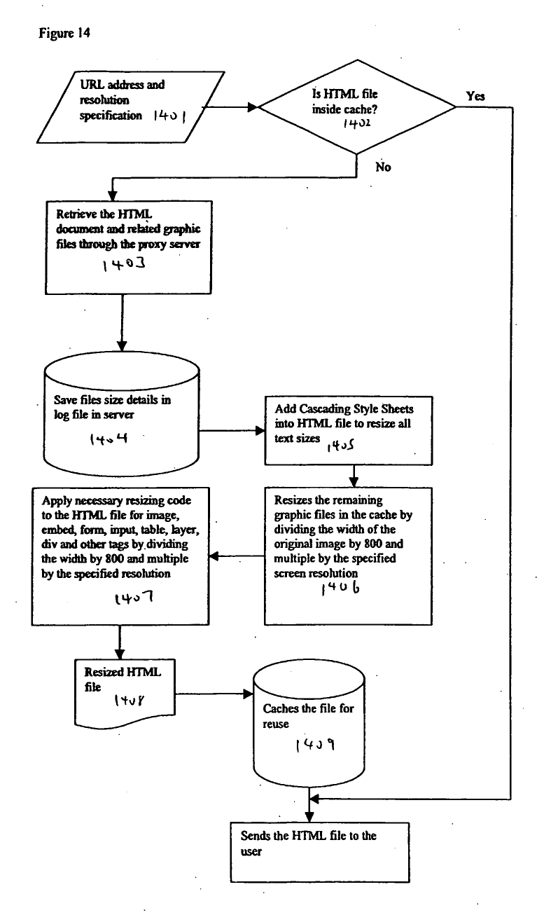

As shown in FIG. 14, once the URL of an HTML document and the resolution of the user's machine display are sent to the server 1401, it will check to determine if the required document is already in the cache 1402. Documents that are not in the cache will be obtained from the Internet 1403. Upon retrieving the document from the Internet, the server will save the operations to a log 1404, and add or amend certain values in the HTML document that resize the text 1405. It then resizes graphic files 1406 to the displayable resolution of the user's machine so it doesn't send unnecessarily large files. Further amendments to the HTML code are made 1407 include the WIDTH and HEIGHT values, and the server resizes tables, embedded material, form, input and other tags supported by the platform. This is not transcoding. No images are thrown away, and the layout of the HTML document will be the same as the original 1408. Any resizing work will be cached 1409 for later reuse.

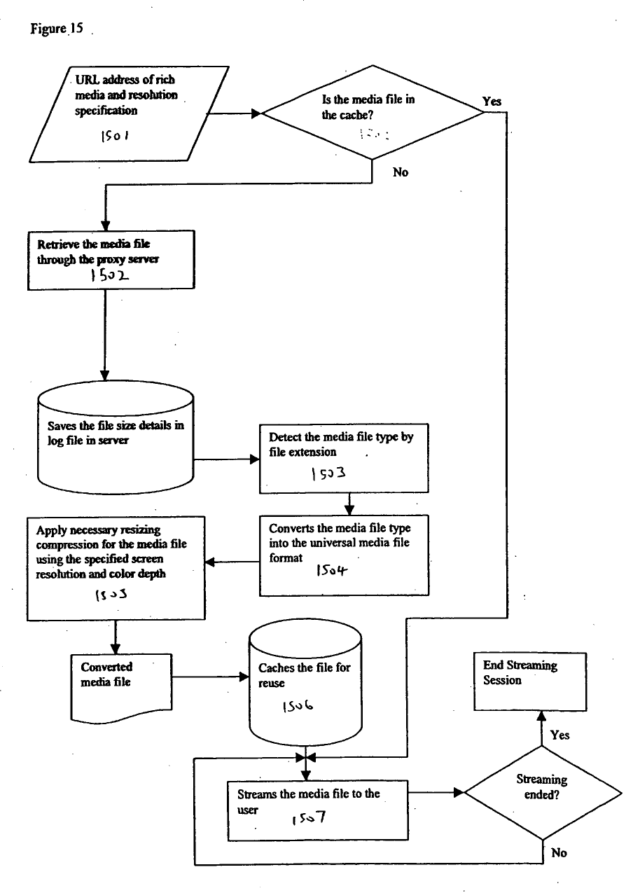

For server streaming media (FIG. 15), given the URL and the request resolution 1501, the server will fetch the required media file 1502 that is not in the cache, and convert the file format to the universal file format. This process involves the detection of the media by file name extension 1503 (the last three letters of a file name) and then converting the file format to the universal file format 1504. This ensures the correct format is output to the platform. The conversion techniques involve either transcoding, or decoding the original file format into output data and re-coding it into the universal format. The technique to be used depends on the original format of the media. Resizing is also performed 1505 so that the server streams smaller files to the platform. Any conversion and resizing performed is automatically cached for later reuse 1506. After conversion and resizing, the server will stream it 1507 to the platform 0100.

The process to launch an application on the platform 0100 is shown in FIGS. 16, 17 and 22. Here, protected environment 2202 refers to access controls issued to applications. An application is not allowed to write to all parts of the disk space in the server, as it could potentially over-write data of other users. Therefore, access controls are to restrict access by applications to restricted areas of the system. It also nirrors the file list from the users'storage area (database) and feeds it to the application 2201. When a file is requested by the application, it is retrieved from the database and copied to the protected environment for processing. When the session closes, or when the application quits, the file is written back to the database. This again ensures there will be no corruption of data. However, an enclosed session, before its timeout, will still hold the “temp” file in case the application fails and a restart occurs. This means that no data is lost.

Once a request is fed to the server 1601, it checks if the application is in the server domain 1602. This is an important check as only trusted applications can be executed by the server 1603/1604. Also, it checks if the user has a subscription for the application 1605. Before execution can start, the server will create a protected environment 1606, something that other application servers normally do not perform. In the protected environment, the server will start the API server that maps the APIs 1607 of the depended native OS of the application to the server APIs. This is done in real time. The server has a set of APIs that is compliant to all native APIs of other OS 1608. Mapping in this case refers to re-direction. Instead of executing native APIs, it now executes a server set of APIs 1609. This gives the server greater control over the applications 1610. Operations covered by the server include exporting the display 1611 to the platform 0100. In consequence GUI instructions are not executed on the server side, and are exported to the user side. Process instructions are executed on the server side. Since the GUI instructions are called through APIs, the server detects these APIs and exports them to the platform 0100. Other operations include re-directing of hardware request and MXI commands that cannot be fulfilled by the server. As hardware requests are called through APIs 1701 the server detects such APIs 1702 and re-directs 1703 them back to the platform for processing. MN commands that cannot be processed but are called on the server end are directed to the platform and executed there 1704. The application will continue to run and process user requests until the session ends, or the user quits the application.

Before mapping can occur, the application must be loaded into the protected execution environment 2202, where the native API calls of other OS are being captured by intercepting the function calls. The protected execution environment first recognizes the native API calls of all other OSs that it supports. When API function calls to the native OS library are detected, the protected execution environment will call its API set, which is equivalent to that being called by the application. The application now runs natively on the server, as all APIs are mapped to the server APIs.

Since all APIs, including GUI and I/O APIs, are mapped to the server APIs, the server has greater control over the application. This allow the server to decide what operations it can export to the platform, and what it can process locally. While executing the application, the protected environment will export API calls the server will not process. Such calls include GUI and I/O calls. GUI API calls are exported directly to the platform, and the platform will process the required GUI components . The term “export” is used to mean that the GUI API are re-directed and called at the platform end. I/O calls are re-directed by calling commands that the platform parses through its platform engine to perform I/O operations.

The advantages of the protected environment is that is provides a secure processing environment that reduces the chances of a virus spreading due to access control restrictions in each protected environment.

The application hosting and execution server incorporates multi-session launching of a single application. This reduces memory use, and impact to the server, as only one copy of the application is required to be loaded in the server memory. This is a standard multi-session technique used in most mainframe systems running UNIX.

In FIG. 18 there is shown a device driver request. “Package” refers to a file that contains multiple compressed files. A package typically includes the core content that is required, in this case the driver files, and also installation instructions executed by the platform 0100.

Once the device header and manufacturer name is fed to the server 1801, it performs a search 1802. If there is a match 1803, the server saves details to a log for referencing purposes, and sends the appropriate package to the user 1805. Since the package is prepared at the server end it is packaged in such a manner that once the platform 0100 receives it, the platform 0100 will unpack the package and run the installation instructions 1806 included in the package. If there is no match, a log record is created in the log file giving the required driver's details 1804. It will then send the administrator a copy 1807 of the details of the required device drivers by email, and sends a report to the user advising that no drivers were found 1808.

To update the operating system is shown in FIG. 19. Here, packages has a similar meaning to that for FIG. 18, except that these contain OS update files instead of drivers. A typical OS update package would include any additional files required by the platform, and installation instructions to be executed by the platform.

The server will check what packages are already installed on the platform of the user 1901. It then compiles a list of packages required 1902. If the list is not empty it will proceed to check if there are any dependencies or other packages 1903. Dependencies are normally covered in the first round, but a second round check for verification purposes is made so that no problems will occur when the platform installs the package 1904. After each dependencies check, if any packages are added to the compiled list an extra round of dependencies check is required. This is to determine if the added packages have any dependencies. Once all the packages are confirmed, the server will send the packages 1905, sequentially 1906 to ensure the first-required packages are those that are received by the platform 0100 and installed first.

The present invention also extends to a software arrangement that is operable on a processor, the software arrangement comprising a computer program that configures the processor to perform one or more of the functions described above. It also extends to a computer system that comprises one or means for performing corresponding one or more of the functions described above.

Whilst there has been described in the foregoing description a preferred embodiment of the present invention, it will be understood by those skilled in the technology that many variations or modifications in details of operation, design or construction may be made without departing from the present invention.

The present invention extends to all features disclosed either individually, or in all possible permutations or combinations.

1. A software system for enabling a server to execute an application for display on a display device of a user's machine, the software system being in a single operating layer architecture in the user's machine.

2. A software system as claimed in claim 1, wherein the software system includes a platform for operating on the user's machine; the platform including a platform engine operating as an operating system.

3. A software system as claimed in claim 2, wherein the operating system is for security, driver support, power management, boot loader, and file system.

4. A software system as claimed in claim 1, wherein the single operating layer architecture is used in the server.

5. A system for a server to download data with constant compression rates to a user's machine to enable an HTML media file to be displayed with real-time streaming on a display device of the user's machine, the HTML media file being converted by the server from a media format to a universal media format agreed between the server and the user's machine.

6. A system as claimed in claim 1, wherein a plurality of applications are executed on the server, all applications being executed on the server under a single operating system such that the display is streamed to the display device without the plurality of applications starting their native operating systems.

7. A system for a server to enable a user's machine operate an application executed on the server, wherein the application is executed in a protected environment in which access controls are implemented to restrict access by the application to at least one restricted area of the system.

8. A system as claimed in claim 7, wherein the application is copied into the protected environment before execution.

9. A system for a server providing an installation of a device driver to a user's machine, the installation being sent by the server to the user's machine with instructions for automatic installation on the user's machine, the instructions being packaged with the installation prior to being sent to the user's machine so that, upon receipt by the user's machine, the user's machine can unpack the installation and the instructions where the device driver files are copied to the system file locations and the system settings updated, execute the instructions, and launch the installation on the user's machine.

10. A system as claimed in claim 9, wherein a record is kept of device driver installations used on the user's machine so that device drivers that are more frequently used are maintained in a memory of tile server.

11. A system as claimed in claim 10, wherein the memory is a read-only-memory.

12. A system as claimed in claim 9, wherein a new file in the installation is copied to the server.

13. A system as claimed in claim 1, wherein the user's machine includes a display device that acts as the display device for the server.

14. A system as claimed in claim 13, wherein a plurality of applications are executed on the server, all applications being executed on the server under a single operating system such that the display is streamed to the display device without the plurality of applications starting their native operating systems.

15. A system as claimed in claim 1, wherein the system operates software in a single operating layer architecture in the user's machine.

16. A system as claimed in claim 15, wherein the software includes a platform for operating on the user's machine; the platform including a platform engine operating as an operating system.

17. A system as claimed in claim 16, wherein the operating system is for security, driver support, power management, boot loader, and file system.

18. A system as claimed in claim 15, wherein the single operating layer architecture is used in the server.

19. A system as claimed in claim 1, wherein the server includes an HTML resizing server for resizing an HTML file before sending the HTML file to the user's machine.

20. A system as claimed in claim 19, wherein any images in the HTML file are resized to be able to be fully displayed on the display device.

21. A system as claimed in claim 19, wherein passing of the HTML file and amendment on the server of code for the HTML file to enable the HTML media file to be displayed on the display device.

22. A system as claimed in claim 1, wherein a plurality of applications are executed on the server, all applications being executed on the server under a single operating system such that the display is streamed to the display device without the plurality of applications starting their native operating systems.

23. A system as claimed in claim 1, wherein the application is executed in a protected environment in which access controls are implemented to restrict access by the application to at least one restricted area of the system.

24. A system as claimed in claim 22, wherein the application is copied into the protected environment before execution.

25. A system as claimed in claim 1, wherein the system includes a platform for operating on the user's machine; the platform including a platform engine operating as an operating system.

26. A system as claimed in claim 25, wherein the operating system is in a single operating layer architecture user's machine.

27. A system as claimed in claim 26, wherein the operating system is for security, driver support, power management, boot loader, and file system.

28. A system as claimed in claim 26, wherein the single operating layer architecture is used in the server.

29. A system as claimed in claim 1, wherein the application is executed in a protected environment in which access controls are implemented to restrict access by the application to at least one restricted area of the system.

30. A system as claimed in claim 29, wherein the application is copied into the protected environment before execution.

31. A system as claimed in claim 1, wherein a plurality of applications are executed on the server, all applications being executed on the server under a single operating system such that the data is streamed to the display device without the plurality of applications starting their native operating systems.

32. A system as claimed in claim 1, wherein the single operating layer architecture includes an engine executor for providing a software interface.

33. A system as claimed in claim 1, wherein the single operating layer architecture includes an engine listener for providing native hardware support.

34. A system as claimed in claim 1, wherein the single operating layer architecture does not have a software layer.

35. A system as claimed in claim 1, wherein application programming interfaces are translated into commands.

36. A system as claimed in claim 1, wherein the user's machine is able to launch, execute, manipulate, monitor and quit applications on the server.

37. A system as claimed in claim 1, wherein the platform recognizes pre-programmed hardware and will not work with unauthorized hardware.

38. A system as claimed in claim 19, wherein the resizing is by adding width and height tags to any object in the file that does not have those tags, and amending the values in the width and height tags so they can be displayed on the display device in accordance with a resolution requirement of the display device.

39. A system as claimed in claim 38, wherein the width tag value is divided by 800 and multiplied by a width of the requested resolution.

40. A system as claimed in claim 38, wherein the height tag value is divided by 600 and multiplied by a height of the requested resolution.

41. A system as claimed in claim 5, wherein the universal media format is pre-determined.

42. A system as claimed in claim 41, wherein the universal media format is a streaming format and has constant compression rates.

43. A system as claimed in claim 41, wherein the conversion to the universal media format is by first decoding and decompression of the HTML media file to raw data.

44. (canceled)

45. A computer system comprising one or means for performing corresponding one or more of the systems comprising:
a software system enabling a server to execute an application for display on a display device of a user's machine the software system being in a single operating layer architecture in the user's machine; or
a system for a server to download data with constant compression rates to a user's machine to enable an HTML media file to be displayed with real-time streaming on a display device of the user's machine, the HTML media file being converted by the server from a media format to a universal media format agreed between the server and the user's machine; or
a system for a server to enable a user's machine operate an application executed on the server, wherein the application is executed in a protected environment in which access controls are implemented to restrict access by the application to at least one restricted area of the system; or
a system for a server providing an installation of a device driver to a user's machine, the installation being sent by the server to the user's machine with instructions for automatic installation on the user's machine, the instructions being packaged with the installation prior to being sent to the user's machine so that, upon receipt by the user's machine, the user's machine can unpack the installation and the instructions where the device driver files are copied to system file locations and the system settings updated, execute the instructions, and launch the installation on the user's machine.

46. A system as claimed in claim 5, wherein a plurality of applications are executed on the server, all applications being executed on the server under a single operating system such that the data is streamed to the display device without the plurality of applications starting their native operating systems.

47. A system as claimed in claim 19, wherein the universal media format is pre-determined.

48. A system as claimed in claim 19, wherein the universal media format is a streaming format and has constant compression rates.

49. A system as claimed in claim 47, wherein the conversion to the universal media format is by first decoding and decompression of the HTML media file to raw data.

50. A computer readable medium containing instructions for a software system enabling a server to execute an application for display on a display device of a user's machine the software system being in a single operating layer architecture in the user's machine.

51. A computer readable medium containing instructions for a system for a server to download data with constant compression rates to a user's machine to enable an HTML media file to be displayed with real-time streaming on a display device of the user's machine, the HTML media file being converted by the server from a media format to a universal media format agreed between the server and the user's machine.

52. A computer readable medium containing instructions for a system for a server to enable a user's machine operate an application executed on the server, wherein the application is executed in a protected environment in which access controls are implemented to restrict access by the application to at least one restricted area of the system.

53. A computer readable medium containing instructions for a system for a server providing an installation of a device driver to a user's machine, the installation being sent by the server to the user's machine with instructions for automatic installation on the user's machine, the instructions being packaged with the installation prior to being sent to the user's machine so that, upon receipt by the user's machine, the user's machine can unpack the installation and the instructions where the device driver files are copied to system file locations and the system settings updated, execute the instructions, and launch the installation on the user's machine.

54. A system as claimed in claim 26, wherein the single operating layer architecture includes an engine executor for providing a software interface.

55. A system as claimed in claim 32, wherein the single operating layer architecture includes an engine listener for providing native hardware support.

56. A system as claimed in claims 33, wherein the single operating layer architecture does not have a software layer.

57. A system as claimed in claims 34, wherein application programming interfaces are translated into commands.

58. A system as claimed in claims 35, wherein the user's machine is able to launch, execute, manipulate, monitor and quit applications on the server.

59. A system as claimed in claims 36, wherein the platform recognizes pre-programmed hardware and will not work with unauthorized hardware.
